(19) United States
(12) Patent Application Publication
(10) Pub. No.: US 2023/0184415 A1
(43) Pub. Date: Jun. 15, 2023

(54) LIGHTING MODULE

(71) Applicant: OPUS NOVO GMBH, Graz (AT)

(72) Inventor: Andreas Frankl, Graz (AT)

(21) Appl. No.: 17/923,667

(22) PCT Filed: May 12, 2020
(86) PCT No.: PCT/AT2020/060195

§ 371 Date: Nov. 7, 2022

(30) Foreign Application Priority Data
May 5, 2020 (AT) A503802020

(51) Int. Cl. F21V 21/15; F21V 23/04

(52) U.S. Cl. CPC F21V 21/15; F21V 23/0471

(57) ABSTRACT

A lighting module emits light in a controlled manner by use of lighting elements. The lighting modules have two lighting elements each arranged in a rotatable manner, in particular about a common axis, and in a pivotal manner. A control unit is in communicative connection with the individual lighting elements, and a sensor measures a parameter, in particular a physical and/or chemical parameter, in the surroundings of the lighting module. The sensor is in communicative connection with the control unit. The sensor is configured to ascertain measurement values of the parameter, in particular in a repeating manner at specified points in time, and the control unit is configured to individually activate selected lighting elements, in particular switch on the selected lighting elements and/or adjust the rotational and/or pivotal position thereof, if a measurement value corresponding to a specified criterion is ascertained by the sensor.

The invention relates to a lighting module for the controlled emission of light by means of lighting elements according to patent claim 1.

A wide variety of circumstances can arise in which people can no longer find their own way, for example, to an exit from a room or a building. In this context, an example of this is heavy smoke development in a building during a fire, which makes it difficult for people to specifically perceive the conditions in a room or building and to find an exit in order to get to safety. Another example in this context is elderly people or people suffering from dementia who, especially at night, have great difficulty orienting themselves even in familiar premises and, for example, finding their way to the bathroom or kitchen.

In this context, various lighting options for individual rooms or associated with pieces of furniture are known from the prior art, e.g. from FR 2982135 A1, DE 19746194 A1, US 2018/315287 A1, US 2017/020297 A1 or EP 1857737 A1, in which the lighting is switched on when, for example, a movement of a person is detected. However, such a conventional lighting of a room combined with a sensor, for example from the ceiling or specific pieces of furniture, is in many cases not suitable for guiding people specifically, for example, to an emergency exit or a specific door, since the entire room is then illuminated but no specific orientation aid is provided. Furthermore, such conventional room lighting can often be perceived as unpleasant or too bright, especially by elderly people or those suffering from dementia, which makes it difficult to fall back asleep.

It is therefore desirable to provide a lighting module that enables a controlled emission of light by means of lighting elements, so that persons can be guided to an exit or to specific premises in a targeted manner by a controlled emission of light, thus ensuring rapid escape from a building in the event of danger or safe travel of a specific path even in the dark or in the event of disorientation.

The invention achieves this object with a lighting module for the controlled emission of light by means of lighting elements according to patent claim 1. According to the invention, it is provided that the lighting module comprises the following components:
at least two lighting elements,
wherein the individual lighting elements are each arranged rotatably, in particular about a common axis, and are each arranged pivotably, in particular with respect to the common axis,
a control unit in communication connection with the individual lighting elements, and
at least one sensor for measuring at least one, in particular physical and/or chemical, parameter in the environment of the lighting module,
wherein the sensor is in communication connection with the control unit,
wherein the sensor is designed to determine, in particular repeatedly at predetermined times, measured values of the at least one parameter, and
wherein the control unit is designed to activate selected lighting elements individually, in particular to switch them on, and/or to adjust their rotational and/or pivoting position when a measured value corresponding to at least one predetermined criterion is determined by the at least one sensor.

This design of a lighting module according to the invention advantageously makes it possible that the areas illuminated by the individual lighting elements or light spots can be set in a targeted manner, so that persons can be guided safely and reliably, for example, to a specific room or an emergency exit when the lighting elements are activated.

Monitoring a suitable parameter in the environment of the lighting module by means of the sensor ensures that the control unit activates the individual lighting elements only when necessary and when the measured value determined by the sensor meets the predetermined criterion. On the one hand, this helps to keep the energy consumption of the lighting module low, since the lighting elements are only activated by the control unit if the measured value determined by the sensor corresponds to the predetermined criterion. On the other hand, this design of the lighting module according to the invention also enables the control unit to activate the individual lighting elements only when this is also necessary, so that people are guided safely to an exit or the entrance to the bathroom, for example, by selected lighting elements of the lighting module being activated by the control unit, for example, being switched on and/or brought into an appropriate rotational and/or pivoting position.

In the context of the invention, a “lighting element” is understood to be any element that can illuminate a specific region in the environment of the lighting module, for example in the form of a light cone or light spot. For this purpose, the lighting element itself can have a light source or illuminant or be illuminated by a separate, external light source and, for example, illuminate a specific environmental area with the aid of a filter or a template.

In the context of the invention, a “parameter” is understood to be any quantity that can be measured by any sensor. In the context of the invention, a “measured value of the parameter” is understood to be the concrete value of the parameter that is determined or detected by a sensor during a concrete measurement.

In order to ensure an optimally illuminated indication of the path to an emergency exit or a door in a specific room, for example, it can be provided that the control unit is designed to deactivate selected lighting elements individually, in particular to switch them off and/or to terminate the adjustment of the rotational and/or pivoting position of the respective lighting element, and/or to dim the brightness of the selected lighting elements when a measured value corresponding to at least one predetermined criterion is determined by the at least one sensor.

A particularly targeted guidance of persons by means of the lighting module can be ensured if the control unit is designed to individually activate and/or deactivate the selected lighting elements and/or to adjust their brightness in a predetermined sequence, in particular at a predetermined time interval from one another.

This design of a lighting module according to the invention advantageously makes it possible to activate the individual selected lighting elements one after the other in a predetermined sequence, for example starting from a place where persons usually stay, such as a bed or desk, so that they reliably point the path to an exit from the room, even if the path there is heavily obstructed by smoke or in the dark.

A lighting module that reliably directs people along a predetermined path and/or illuminates such a path under a wide variety of circumstances can be provided when the at least one sensor is
a motion sensor, in particular an ultrasonic motion sensor or an infrared motion sensor, or
a vibration sensor, in particular an acceleration sensor, or
a photoelectric sensor, in particular a diffuse reflection sensor, or
a sensor that is sensitive to at least one chemical substance, in particular a pollutant, in particular a sensor sensitive to CO₂.

The use of such sensors can ensure, for example, that the control unit activates the individual selected lighting elements when the movement of a person is detected in the environment of the lighting module, or when, for example, a person lying in a bed leaves the bed, or when, for example, a particular chemical substance or pollutant is present in the environment of the lighting module.

A particularly targeted determination of the activation, deactivation and/or dimming of the individual selected lighting elements by the control unit adapted to the intended use or place of use of the lighting module can be ensured if the control unit is designed to use at least one of the following criteria for activating and/or deactivating and/or adjusting or dimming the brightness of the lighting elements:
that the measured value of the, in particular physical and/or chemical, parameter determined by the sensor indicates a movement of a person in the environment of the lighting module,
that the measured value of the, in particular physical and/or chemical, parameter determined by the sensor indicates that no person is moving in the environment of the lighting module,
that the change over time of the measured value of the, in particular physical and/or chemical, parameter determined by the sensor exceeds a predetermined threshold value,
that the measured value of the, in particular physical and/or chemical, parameter determined by the sensor exceeds a predetermined threshold value.

The definition of at least one of these criteria for the activation or deactivation or dimming of the lighting elements by the control unit advantageously enables lighting modules to be used in a targeted manner, for example in care facilities for the prevention of falls of persons in need of care or in a system guiding persons to emergency exits.

A lighting module that particularly reliably ensures that the individual lighting elements are activated only when a person in need of care moves out of bed, but not when, for example, a caregiver enters the room, can be provided if the lighting module comprises a motion sensor and a vibration sensor, and if the control unit is designed to
upon simultaneous detection of a movement of a person in the environment of the lighting module by the movement sensor and the vibration sensor, activate the lighting elements individually in a predetermined sequence, and in particular to subsequently keep them activated for a predetermined period of time,
deactivate the lighting elements if no movement of a person in the environment of the lighting module is detected by the motion sensor and the vibration sensor, and
upon detection of a movement of a person in the environment of the lighting module only by the motion sensor, activate the lighting elements individually in reverse order.

A particularly targeted e.g. activation of the individual selected lighting elements by the control unit, which can be adapted to the speed at which a person moves through a room or building, can be ensured,
if a plurality of sensors of the same type are arranged on the lighting module in such a manner that each of the sensors measures at least one physical and/or chemical parameter in a predetermined subregion of the environment of the lighting module,
if a lighting element is assigned to each of the sensors, and
if the control unit is designed to activate and/or deactivate the lighting element assigned to the respective sensor and/or to adjust its brightness, in particular to dim it, when a measured value corresponding to at least one predefined criterion is determined by a sensor.

This design of a lighting module according to the invention advantageously makes it possible for the individual sensors to monitor subregions of the environment of the lighting module and, if a corresponding measured value is determined by the sensor in this subregion, to activate, deactivate or dim the lighting element assigned to this subregion.

For example, in order to ensure optimal lighting intensity by the individual lighting elements, even if a room is already heavily obscured by smoke, or also in order not to impair a person's sleep rhythm by lighting that is too bright, it can be provided that
the lighting module comprises a brightness sensor for determining a measured value of the brightness in the environment of the lighting module, wherein the brightness sensor is in data communication with the control unit and
the control unit is designed to adjust the brightness of the lighting elements as a function of the brightness measured value determined by the brightness sensor.

The brightness measured values provided by such a brightness sensor can advantageously also be used to derive information about the time of day, so that the control unit can control the lighting elements to indicate different paths depending on the time of day, or can also control the charging of, for example, a battery housed in the lighting module.

An optimal adaptation of the lighting module according to the invention to the respective spatial conditions or a particularly individually adaptable setting of the areas illuminated by the individual lighting elements or light spots can be achieved if the individual lighting elements each comprise the following components:
a light source, in particular a light-emitting diode, and
a lens and/or a focusing element, in particular of hollow cylindrical design, for adjusting the environmental area illuminated by the light source, in particular a light spot.

A particularly targeted guidance of, for example, persons in need of care to different regions or rooms in their home, adapted, for example, to their needs which vary according to the time of day, can be achieved if each lighting element comprises multi-color light sources, in particular multi-color light-emitting diodes or multiple light-emitting diodes emitting light of different wavelengths, wherein it can be provided in particular that the control unit is designed to
select the light color emitted by the light sources as a function of the brightness measured value determined by the brightness sensor and/or
determine the time of day and select the light color emitted by the light sources depending on the time of day.

A particularly targeted automated adjustment of the rotational and pivoting position of the individual lighting elements can be achieved if each lighting element comprises an adjustment device for adjusting the rotational position and/or the inclination of the lighting element, in particular with respect to the common axis, wherein the adjustment device is connected downstream of the control unit, wherein it can be provided, in particular, that the control unit is designed to
adjust the rotational position and/or the inclination of the respective lighting element as a function of the brightness measured value determined by the brightness sensor by means of the adjustment device and/or
determine the time of day and adjust the rotational position and/or the inclination of the respective lighting element as a function of the time of day by means of the adjustment device.

This design of a lighting module according to the invention advantageously enables the control unit to adjust the rotational and pivoting position or inclinations of the individual lighting elements in a particularly targeted manner, for example, as a function of the measured values of the sensor monitoring the environment of the lighting module or also as a function of the measured values of, for example, a brightness sensor.

A possibility for a particularly simple expansion of a lighting module can be provided if the lighting module is constructed modularly from a plurality of individual segments, wherein each lighting element is accommodated in a separate segment in each case and wherein the lighting module is expandable by further segments, in particular by further segments with lighting elements.

In this way, it is advantageously possible, for example, to add segments with lighting elements or also to remove them again if the lighting module is to be used successively at different locations, for example. For example, it is possible to add additional segments with lighting elements to achieve adaptation to the respective spatial conditions and, for example, to achieve a particularly dense sequence of lighting points or to illuminate a particularly long distance, for example to an emergency exit.

A lighting module according to the invention can be designed to be particularly compact if the lighting module has a substantially cylindrical shape, wherein it can be provided in particular that the segments of the lighting module form subsections of the lighting module with a substantially cylindrical shape.

A particularly simple manual or also automated adjustment of the rotational position of the individual lighting elements or segments can be achieved if selected segments of the lighting module, in particular selected segments with lighting elements, can be rotated about the longitudinal axis of the lighting module.

In order to ensure a particularly targeted and interference-free measurement of the parameter in the environment of the lighting module by the sensor while at the same time ensuring a particularly compact design of the lighting module, it can be provided that the control unit and the at least one sensor are accommodated in a common, in particular hemispherical, control/sensor segment,

wherein it can, in particular, be provided
that the control/sensor segment forms one end of the lighting module and/or
that the control/sensor segment comprises a stationary light source, in particular a light-emitting diode, connected downstream of the control unit.

A particularly simple mounting of a lighting module according to the invention on various locations of a piece of furniture can be ensured if the lighting module comprises a holding device, wherein the holding device is designed for fastening the lighting module on a piece of furniture, in particular a bed, preferably a foot part or a head part of a care bed.

For example, a lighting module can thus be arranged on a piece of furniture with particularly little assembly effort and at the same time permanently and reliably, or removed again if required. In this context, a piece of furniture can also have a receiving device designed as a counterpart to the holding device, so that the lighting module can be fastened particularly easily.

A particularly reliable guidance of people, for example, across several rooms or corridors of a building to, for example, an emergency exit can be ensured,
if the lighting module comprises a communication unit, in particular with WLAN or Bluetooth capability, wherein the communication unit is connected downstream of the control unit,
if the communication unit is designed to establish a communication connection with further, in particular similarly constructed, lighting modules and/or, in particular, lighting units with WLAN or Bluetooth capability, and
if the control unit is designed, when a measured value corresponding to at least one predetermined criterion is determined by the at least one sensor,
   to activate and/or deactivate selected lighting units and/or dim their brightness
and/or
   to control the control unit of selected further lighting modules to activate and/or deactivate and/or dim the brightness of selected lighting elements of the further lighting modules.

In this way, the lighting module can communicate with further lighting modules or other lighting units and, by means of the control unit, cause a targeted activation of the individual lighting elements of the further lighting modules, so that overall a reliable illumination of the escape route through, for example, an entire building is ensured.

To make it possible for individual selected lighting elements to be activated by the control unit if, for example, a patient requires particularly urgent medical assistance or the help of a caregiver, it can be provided that
the lighting module comprises a communication unit, in particular with WLAN or Bluetooth capability, wherein the communication unit is connected downstream of the control unit,
the communication unit is designed to establish a communication connection with at least one vital parameter sensor, in particular with WLAN or Bluetooth capability, for monitoring a vital parameter, in particular pulse, blood pressure, respiratory rate, blood sugar or body temperature, of a person, and
that the control unit is designed to activate selected lighting elements and/or the stationary light source if the measured vital parameter exceeds or falls below a predetermined threshold value.

For example, if such a vital parameter sensor is fastened to a person or patient and sends measured values to the communication unit, the control unit can activate, deactivate or dim individual selected lighting elements if the measured vital parameter reaches a critical value for the patient.

In order to particularly reliably prevent the control unit of the lighting module from activating selected lighting elements when, for example, a caregiver is moving in the environment of the lighting module and no activation of the lighting elements is required because the person to be guided by this activation has not left the bed, it can be provided that
the lighting module comprises a communication unit, in particular with WLAN or Bluetooth capability, wherein the communication unit is connected downstream of the control unit,
the communication unit is designed to establish a communication connection with at least one external sensor, in particular with WLAN or Bluetooth capability, for measuring at least one physical and/or chemical parameter, and
the control unit is designed to keep selected lighting elements in a deactivated state if the physical and/or chemical measured value determined by the at least one external sensor indicates a movement of a person in the environment of the external sensor.

For example, if the external sensor detects movement of a person at an entrance door to a patient room, the control unit keeps the selected lighting elements in a deactivated state.

Further advantages and embodiments of the invention will be apparent from the description and the accompanying drawings.

Particularly advantageous, but not restrictive, exemplary embodiments of the invention are illustrated schematically below with reference to the accompanying drawings and described by way of example with reference to the drawings.

The figures schematically show the following:

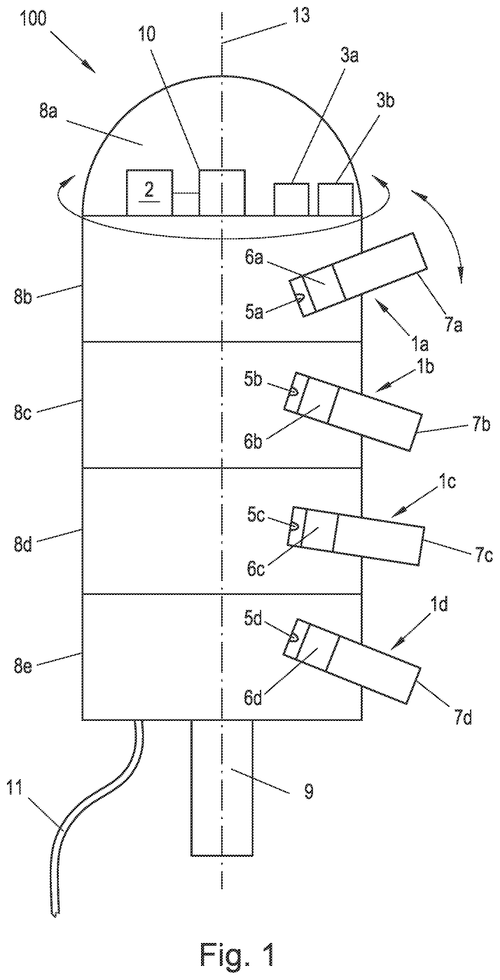

FIG. 1 shows a first exemplary embodiment of a lighting module according to the invention with an external power supply,

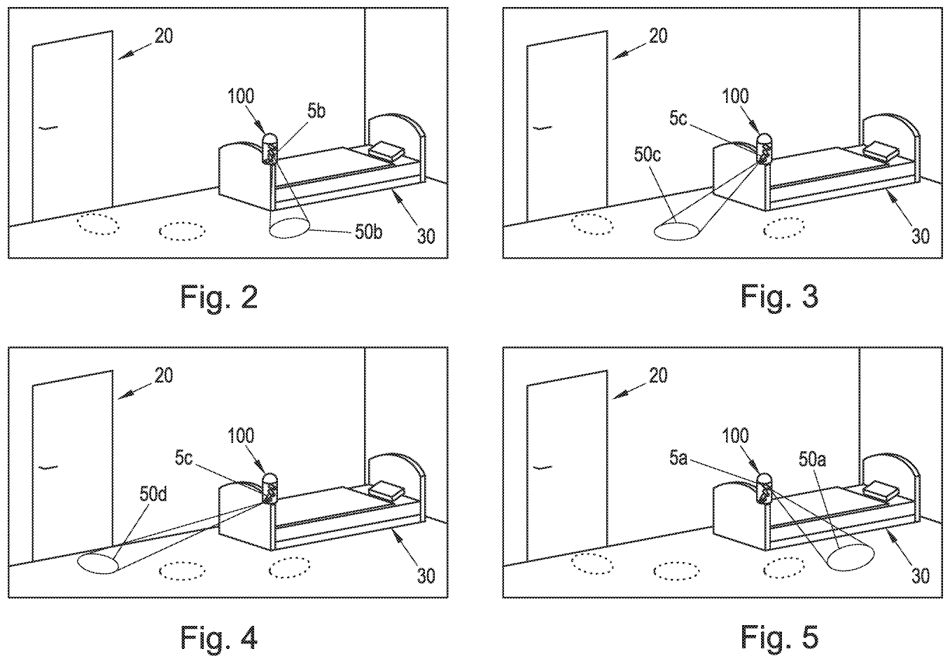

FIG. 2 to FIG. 5 show a care bed on which a second exemplary embodiment of a lighting module according to the invention is mounted,

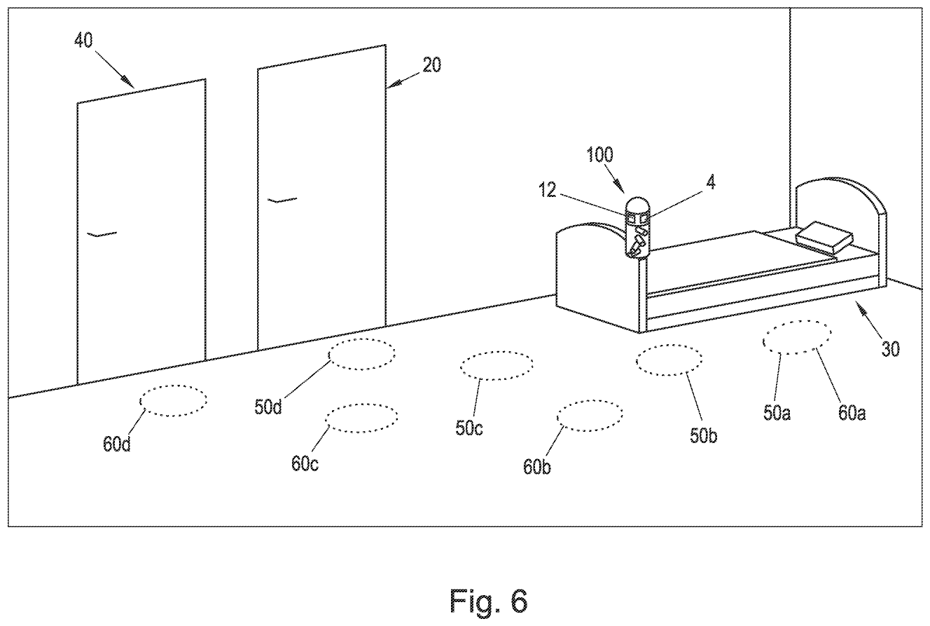

FIG. 6 shows a care bed on which a third exemplary embodiment of a lighting module according to the invention is mounted,

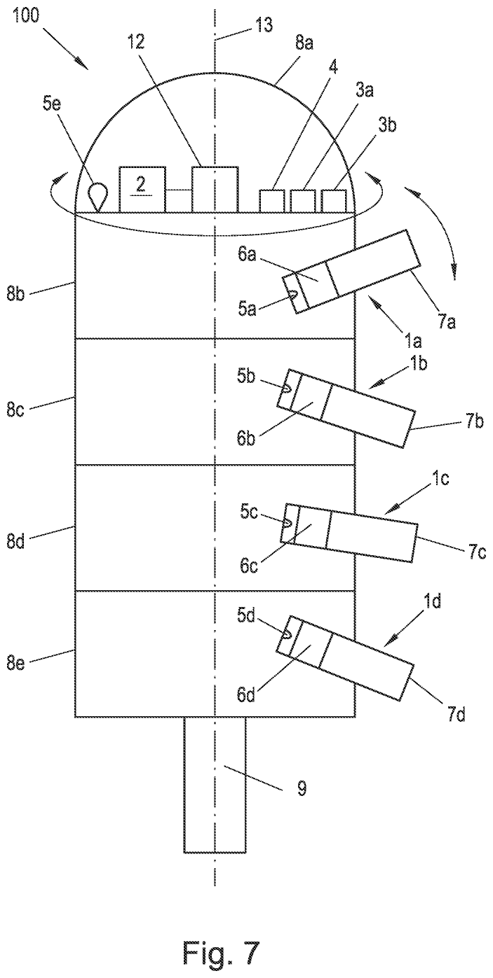

FIG. 7 shows a detailed view of the third exemplary embodiment of a lighting module according to the invention of FIG. 6.

FIG. 1 shows a first exemplary embodiment of a lighting module 100 according to the invention for the controlled emission of light by means of lighting elements 1a, . . . , 1d in a schematic sectional view. The lighting module 100 in the first exemplary embodiment has four lighting elements 1a, . . . , 1d. However, this number of lighting elements 1 is by no means mandatory, since a lighting module according to the invention has at least two lighting elements 1, but can in principle have any number of lighting elements 1 in addition.

As can be seen in FIG. 1, the individual lighting elements 1a, . . . , 1d of the lighting module 100 are individually rotatably and individually pivotably arranged on the lighting module 100. In the first exemplary embodiment, the individual lighting elements 1a, . . . , 1d can each be rotated about a common axis 13 and be pivoted in the direction of the common axis 13. In the first exemplary embodiment, this common axis 13 is defined by the longitudinal axis of the lighting module 100.

The lighting module 100 of the first exemplary embodiment has a substantially cylindrical shape and is modularly constructed from a plurality of individual segments 8a, . . . , 8e. As can be seen in FIG. 1, each lighting element 1a, . . . , 1d is accommodated in a separate segment 8b, . . . , 8e in the first exemplary embodiment. The individual segments 8b, . . . , 8e in which lighting elements 5a, . . . , 5d are accommodated also have a substantially cylindrical shape and thus form subsections of the lighting module 100. This modular design of the lighting module 100 makes it possible for the lighting module 100 to be expanded in a particularly simple manner to include, for example, additional segments 8 with lighting elements 1.

As schematically indicated in FIG. 1, the individual segments 8a, . . . , 8e of the lighting module 100 can be rotated about a common axis 13, which in the first exemplary embodiment is the longitudinal axis of the lighting module 100. In this way, the rotational position of the individual lighting elements 1a, . . . , 1d can be adjusted particularly easily, either manually or automatically.

As further schematically shown in FIG. 1, the lighting module 100 in the first exemplary embodiment comprises a control unit 2, e.g. a microprocessor, which is in communication connection with the individual lighting elements 1a, . . . , 1d. On the one hand, this can be achieved by connecting the control unit 2 to the individual lighting elements 1a, . . . 1d via a cable connection. Alternatively, the communication connection can also be established via a WLAN or radio connection such as Bluetooth, for example.

As can be further seen in FIG. 1, a lighting module 100 according to the invention further comprises at least one sensor 3 for measuring at least one parameter in the environment of the lighting module 100. This parameter is in particular a physical and/or chemical parameter. The sensor 3 is in communication connection with the control unit 2 and determines measured values of the at least one, in particular physical and/or chemical, parameter. The sensor 3 can, for example, determine measured values of the parameter repeatedly at predetermined times as an active sensor or also provide measured values in the form of a passive sensor as soon as a change in the monitored parameter is determined.

If a measured value corresponding to at least one predetermined criterion is determined by the at least one sensor 3, the control unit 2 activates selected lighting elements 1a, . . . , 1d individually, i.e. it switches them on individually and/or adjusts their rotational and/or pivoting position, for example.

As can be seen in FIG. 1, in the first exemplary embodiment, the lighting module 100 comprises two sensors 3a, 3b, which are a motion sensor 3a, for example an ultrasonic motion sensor or an infrared motion sensor, and a vibration sensor 3b, for example an acceleration sensor.

In addition or alternatively, a photoelectric sensor, for example a diffuse reflection sensor, or a sensor sensitive to at least one chemical substance can also be used as a sensor 3 in a lighting module 100 according to the invention. Thus, such a sensor 3 can also be, for example, a pollutant sensor, such as a sensor sensitive to carbon dioxide.

The control unit 2 of each lighting module 100 according to the invention is designed to activate the lighting elements 1a, . . . , 1d individually, i.e., for example, to switch them on and/or to adjust the rotational and/or pivoting position of selected lighting elements 1a, . . . , 1d.

In the first exemplary embodiment, the control unit 2 of the lighting module 100 is also designed to individually deactivate selected lighting elements 1a, . . . , 1d, i.e., for example, to switch them off and/or to stop adjusting the rotational and/or pivoting position and/or also to dim the brightness of the selected lighting elements 1a, . . . 1d.

In the first exemplary embodiment, for example, the control unit 2 can activate and/or deactivate the selected lighting elements 1a, . . . , 1d individually and/or dim their brightness in a predetermined sequence. This can be done not only immediately one after the other, but also at a predetermined time interval from each other. This will be discussed in further detail below in connection with the second and third exemplary embodiments of a lighting module 100 according to the invention.

As criteria for activating and/or deactivating and/or dimming the brightness of the individual lighting elements 1a, . . . , 1d, the control unit 2 of a lighting module 100 according to the invention can generally use at least one or a combination of the following criteria:
that the measured value of the, for example physical and/or chemical, parameter determined by the sensor 3 indicates a movement of a person in the environment of the lighting module 100,
that the change over time of the measured value of the, for example physical and/or chemical, parameter determined by the sensor 3 exceeds a predetermined threshold value,
that the measured value determined itself exceeds a predetermined threshold value,
that the measured value of the, for example physical and/or chemical, parameter determined by the sensor 3 indicates that no person is moving in the environment of the lighting module.

In the first exemplary embodiment, the control unit 2, the motion sensor 3a and the vibration sensor 3b are accommodated in a common, hemispherical, control/sensor segment 8a. This design of a control/sensor segment 8a enables a particularly efficient determination of measured values in the environment of the lighting module 100.

However, such a control/sensor segment 8a can also have a substantially cylindrical or other suitable shape. The control unit 2 and the at least one sensor 3 can also be accommodated separately from one another in different segments 8.

In the first exemplary embodiment, the control/sensor segment 8a forms one end of the lighting module 100. However, this design possibility is also optional.

In the first exemplary embodiment, the lighting module 100 further has an external power supply, which is schematically indicated by a power cable 11 leading into the lighting module 100 in FIG. 1.

As in the first exemplary embodiment, a lighting module 100 according to the invention can also comprise a holding device 9 for fastening the lighting module 100 to a piece of furniture, such as the foot part or head part of a bed, which will be discussed in further detail below.

Optionally, in all conceivable exemplary embodiments of a lighting module 100 according to the invention, the individual lighting elements 1a, . . . , 1d can also each comprise an adjustment device for adjusting the rotational position and/or the pivoting position or the inclination of the respective lighting element 1a, . . . , 1d with respect to, for example, the common axis 13, which is, however, not shown in FIGS. 1 to 6.

By means of such an adjustment device, the rotational position and/or the pivoting position or inclination of the respective lighting element 1a, . . . , 1d can be manually adjusted in a simple embodiment. However, such an adjustment device can also be connected downstream of the control unit 2 so that the control unit 2 can automatically adjust the rotational and/or pivoting position when a measured value corresponding to at least one predetermined criterion is determined by the at least one sensor 3.

In all conceivable exemplary embodiments of a lighting module 100 according to the invention, the control unit 2 can optionally also be designed to determine the time of day and to adjust the rotational position and/or the inclination of the respective lighting element 1a, . . . , 1d as a function of the time of day by means of the adjustment device and/or to adjust the rotational position and/or the inclination of the respective lighting element 1a, . . . , 1d as a function of, e.g. a brightness measured value determined by the brightness sensor by means of the adjustment device, which will be discussed in more detail in connection with the third exemplary embodiment.

In the first exemplary embodiment schematically shown in FIG. 1, the individual lighting elements 1a, . . . 1d of the lighting module 100 each comprise a light source 5a, . . . , 5d and, for adjusting the environmental area respectively illuminated by the light source 5a, . . . , 5d or a light spot, a lens 6a, . . . , 6d and a focusing element 7a, . . . , 7d. Optionally, additional covers can also be provided.

As can be seen in FIG. 1, the individual lighting elements 1a, . . . 1d in the first exemplary embodiment each comprise a light-emitting diode as a light source 5a, . . . , 5d, a lens 6a, . . . , 6d and a focusing element 7a, . . . , 7d, which is designed to be hollow cylindrical.

In the first exemplary embodiment, the light-emitting diodes on the LED boards are arranged inside the lighting module 100 or inside the respective segment 8a, . . . , 8d, and guide the light outwardly into the environment of the lighting module 100 via the lens 6a, . . . , 6d and the focusing element 7a, . . . , 7d, in the direction predetermined by the adjustment of the rotational and pivoting position.

As an alternative to being arranged inside the lighting module 100, the lighting elements 1a, . . . , 1d can also be arranged on the outside of the lighting module 100 or the respective segment 8a, . . . , 8d of the lighting module 100 in all conceivable exemplary embodiments of a lighting module 100 according to the invention.

Active or passive electronic circuits, such as constant current sources, can also be placed on the LED boards in all conceivable exemplary embodiments of a lighting module 100 according to the invention.

Optionally, in all conceivable exemplary embodiments of a lighting module 100 according to the invention, a further focusing element or a further optical component such as a further lens, for example, can also be plugged onto the focusing elements 7a, . . . , 7d, so that the exit angle of the light from the focusing elements 7a, . . . , 7d can be set particularly precisely.

Thus, different further focusing elements or further optical components can be provided for different distances of the environmental area to be illuminated or of the generated light spots from the lighting module 100. In this way it can be achieved, for example, that all light spots 50a, . . . , 50d; 60a, . . . , 60d on the floor have the same diameter, although they are generated at different distances from the lighting module 100 on the floor, since a varying scattering of the light can be achieved by the further focusing elements or further optical components, or the exit angle/emission angle for the individual lighting elements 1a, . . . 1d can be set particularly precisely.

In this context, in all conceivable exemplary embodiments of a lighting module 100 according to the invention, the control unit 2 can optionally also be designed to automatically detect whether, and if so, which lens 6a, . . . , 6d and/or which focusing element 7a, . . . , 7d or whether, and if so, which further focusing elements or further optical components are currently arranged on the individual lighting elements 1a, . . . , 1d.

One way of enabling automatic detection of the lens 6a, . . . , 6d and/or the focusing element 7a, . . . , 7d or a further focusing element or further optical component currently arranged on the individual lighting elements 1a, . . . 1d can be provided, for example, by a pressure sensor which is automatically activated or loaded when the respective component is attached and transmits a signal to this effect to the control unit 2. Alternatively, a pushbutton can be provided which is activated when the respective component is attached.

Optionally, several different pushbuttons can also be provided, each of which is assigned to different components so that a different pushbutton is activated in each case and sends a signal to the control unit 2, thus making it possible to distinguish between the components. This is particularly advantageous because different components require different light intensities to achieve the same brightness at the point of appearance. In this way, the control unit 2 can automatically detect which light brightness is required to achieve the desired lighting characteristic.

Optionally, each lighting element 1a, . . . , 1d or individual lighting elements 1 can also comprise a glass body or diffuser for adjusting the radiation characteristic.

A lighting module 100 according to the invention can be used to particular advantage in the care sector for preventing falls in persons in need of care. The prevention of falls is one of the greatest challenges in the care of people in need of care. The risk of injury to persons at risk of falling is particularly high at night due to increased risk factors such as low basic brightness in the room, impaired vision, fatigue, confusion, or limited availability of professional caregivers or family caregivers.

In the following, therefore, with reference to FIG. 2 to FIG. 5, a second exemplary embodiment of a lighting module 100 according to the invention is described, which is arranged with a holding device 9, as can be seen in detail in the first exemplary embodiment, on a foot part of the care bed 30 in a care facility for persons in need of care.

In this regard, the second exemplary embodiment of a lighting module 100 according to the invention has the same structure as the lighting module 100 of the first exemplary embodiment. As in the first exemplary embodiment, the lighting module 100 in the second exemplary embodiment comprises a motion sensor 3a and a vibration sensor 3b. This sensor combination is particularly suitable for reliably detecting when a person leaves the care bed 30.

A care bed 30 as schematically shown in FIG. 2 to FIG. 5 can have at several locations a—pre-installed or subsequently mounted—receiving device for receiving the holding device 9 of a lighting module 100 according to the invention. Advantageously, such a receiving device also allows a lighting module 100 to be subsequently arranged on the respective care bed 30 and also to be removed again, or the position of the lighting module 100 to be changed, for example, if the position of the care bed 30 in the room is changed.

Older people in particular often wake up repeatedly during the night and feel the need to go to the bathroom, wherein going to and from the bathroom massively increases the risk of a fall or injury. Since, as previously mentioned, conventional room lighting is often perceived by the persons concerned as unpleasant and too bright, thus making it difficult to fall back asleep, a lighting module 100 according to the invention advantageously offers the possibility of creating a safe and pleasant lighting environment for the persons concerned, by which the way to the bathroom is made safer and the sleeping rhythm is not impaired.

In order to ensure this, the control unit 2 of the lighting module 100 is designed, as previously described, to activate selected lighting elements 1a, . . . , 1d individually, e.g. to switch them on and/or adjust their rotational and/or pivoting position when a measured value corresponding to at least one predetermined criterion is determined by the at least one sensor 3 of the lighting module 100.

In simplified terms, the lighting elements 1a, . . . , 1d in the second exemplary embodiment can therefore be controlled by the control unit 2 according to a specific “dimming rhythm”. Thus, the individual lighting elements 1a, . . . , 1d can be controlled individually to indicate a certain path and, for example, individually dimmed bright and dark again or switched on and off again one after the other. In this way, a person who is to move from, for example, his care bed 30 to a certain destination, such as the door 20 to the bathroom, can be provided with successive light spots 50a, . . . , 50d to which he is to move.

When the at least one sensor 3 detects that the person is no longer in the immediate vicinity of the care bed 30, the dimming rhythm can be applied in reverse order, in simplified terms, so that the light spot 50d furthest away from the care bed 30 is switched on first and thus provides the patient the path back to the care bed 30. This procedure will now be explained in more detail with reference to the second exemplary embodiment of a lighting module 100 and FIG. 2 to FIG. 5:

In FIG. 2 to FIG. 5, the lighting module 100 is intended to indicate the path to the bathroom or to the door 20 into the bathroom, starting from the care bed 30, as soon as a person leaves the care bed 30. This is done by controlled emission of light by means of the individual lighting elements 1a, . . . 1d in the form of individual light spots 50a, . . . , 50d, which guide the person in the direction of their destination, in FIG. 2 to FIG. 5 this is the door 20 to the bathroom. For this purpose, the rotational and pivoting positions or inclinations of the individual lighting elements 1a, . . . , 1d are adjusted such that the distance to be covered is precisely indicated. The rotational and pivoting positions of the individual lighting elements 1a, . . . , 1d can be adjusted either manually or automatically by the control unit 2 by means of an adjustment device, e.g. according to specifications entered by a caregiver using an input unit. For this purpose, the lighting module 100 can comprise an input unit, e.g. a display with a touch screen, in order to be able to enter specifications for the control software.

As previously mentioned, the second exemplary embodiment of a lighting module 100 comprises a motion sensor 3a and a vibration sensor 3b instead of a single sensor 3, which in combination are particularly reliable in detecting whether a person lying in the care bed 30 leaves the care bed 30. The vibration sensor 3b detects any movement in the care bed 30, which is also transmitted to the bed frame and thus to the lighting module 100 in the form of vibrations or shocks. However, the control unit 2 does not activate the lighting elements 1a, . . . , 1d until the motion detector 3a also detects a movement, since only then can it be ensured that the person has actually left the care bed 30 and has not just, for example, turned around in the care bed 30 while sleeping. An activation of the lighting elements 1a, . . . , 1d would not be desired in this case, since the person would be undesirably awakened, which would significantly disturb the person's sleep rhythm.

Thus, if the motion sensor 3a and the vibration sensor 3b simultaneously detect a movement of a person in the environment of the lighting module 100, this is an indication that the person who was previously sleeping in the care bed 30 is leaving or has just left the care bed 30. In this case, the control unit 2 switches on the lighting elements 1a, . . . , 1d individually in a predetermined sequence and then keeps them activated for a predetermined period of time, if necessary.

The control unit 2 first activates the lighting element 5b or switches it on, as can be seen in FIG. 2, and a first light spot 50b is thus generated, which specifies the starting direction for the path to be followed. This first light spot 50b is located at a certain distance from the care bed 30 in the direction of the door 20 to the bathroom.

Subsequently, after a predetermined period of time corresponding, for example, to the time required for a person to cover the distance to the first light spot 50b, the control unit 2 activates the lighting element 5c or switches it on, and a second light spot 50c is thus generated, which is already located further in the direction of the door 20 to the bathroom. This is shown schematically in FIG. 3.

After a predetermined period of time corresponding, for example, to the time required for a person to cover the distance to the second light spot 50c, the control unit 2 activates the lighting element 5d or switches it on, and a third light spot 50d is thus generated, which in the second exemplary embodiment is located directly in front of the door 20 to the bathroom. This is shown schematically in FIG. 4.

When no more movement of the person in the environment of the lighting module 100 is detected by the motion sensor 3a and the vibration sensor 3b, i.e. the person has entered the bathroom through the door 20, the control unit 2 deactivates the lighting elements 1a, . . . 1d, i.e. it switches them off to save energy.

If only the motion sensor 3a detects a movement of a person in the environment of the lighting module 100, the control unit 2 detects that the person is returning from the bathroom and the control unit 2 activates the lighting elements 1b, 1c, 1d individually in reverse order, at a predetermined time interval from each other, i.e., it switches them on again in reverse order to guide the person back to the care bed 30.

Finally, in order to facilitate the person's entry into the care bed 30, the control unit 2 activates or switches on the lighting element 5a, thus creating a fourth light spot 50a located immediately in front of the care bed 30. In this way, the person finds his way back to the care bed 30 at the right place. This is shown schematically in FIG. 5.

The control unit 2 deactivates or switches off the lighting element 1a that was last activated or switched on when the movement of a person is again simultaneously registered by the motion sensor 3a and a vibration of the care bed 30 is registered by the vibration sensor 3b, which means that the person is again in the care bed 30.

Optionally, in all conceivable exemplary embodiments of a lighting module 100 according to the invention, the lighting module 100 can also comprise a communication unit 10, in particular with WLAN or Bluetooth capability, which is connected downstream of the control unit 2. Such a communication unit 10 is shown schematically in FIG. 1. If the lighting module 100 has such a communication unit 10, a communication connection can be established with, for example, at least one external sensor, in particular with WLAN or Bluetooth capability, for measuring at least one physical and/or chemical parameter, which can be, for example, a photoelectric sensor that can be arranged at the entrance to the patient's room, through which caregivers usually enter the patient's room.

If the physical and/or chemical measured value determined by such an external sensor indicates a movement of a person in the environment of the external sensor, the control unit 2 recognizes that it is not the person lying in the care bed 30 who is moving or leaving the care bed 30, but that a caregiver has entered the patient room. Therefore, the control unit 2 keeps the selected or all lighting elements 1a, . . . , 1d in the deactivated state then.

Optionally, in all conceivable exemplary embodiments of a lighting module 100 according to the invention, it is also possible for the lighting module 100 to comprise a plurality of sensors 3 of the same type, such that each of the sensors 3 measures at least one physical and/or chemical parameter in a predetermined subregion of the environment of the lighting module 100, wherein each of the sensors 3 is assigned a lighting element 1a, . . . , 1d.

With several sensors 3 of the same type, it is possible for the control unit 2 to activate or deactivate the individual lighting elements 1a, . . . , 1d or to dim their brightness in a particularly targeted manner when a measured value corresponding to at least one predetermined criterion is determined by the sensor 3 assigned to the respective lighting element 1a, . . . , 1d.

If, for example, several motion sensors 3a are arranged at the periphery of the lighting module 100, the control unit 2 can advantageously switch on the lighting elements 1a, . . . , 1d in exact coordination with the approach of the person, e.g., independently of, for example, a predetermined period of time.

In the following, with reference to FIG. 6 and FIG. 7, a third exemplary embodiment of a lighting module 100 according to the invention is described, which is also arranged with a holding device 9, as can be seen in detail in the first exemplary embodiment, on a foot part of a care bed 30 in a care facility for persons in need of care.

The third exemplary embodiment of a lighting module 100 according to the invention is similar in structure to the lighting module 100 of the first exemplary embodiment, but it has a battery 12 instead of an external power supply. In the third exemplary embodiment, the control/sensor segment 8a forms one end of the lighting module 100 and comprises a stationary light source 5e, such as a light-emitting diode, connected downstream of the control unit 2.

In the third exemplary embodiment, the lighting module 100 further comprises a brightness sensor 4 for determining a measured value of brightness in the environment of the lighting module 100. The brightness sensor 4 is in data communication with the control unit 2, and the control unit 2 can set the brightness of the lighting elements 1a, . . . , 1d as a function of the brightness measured value determined by the brightness sensor 4, which naturally varies depending on the time of day and light conditions or weather conditions, but also, for example, depending on the strength of a smoke development in a burning building.

For example, at dusk or when smoke development is light, less intense light is required to indicate a path to a specific door in a room or to the emergency exit from a building, whereas when smoke development is heavy, for example, a high lighting intensity is required to ensure effective indication of an escape route, for example.

A major problem for the elderly is that they often wake up several times during the night and have to make their way to the bathroom. On the one hand, this shortens the duration of sleep, and on the other hand, the quality of sleep also suffers. In addition, older persons often find it difficult to fall back asleep if, for example, the room lighting is too bright, which impairs their sense of well-being. The right brightness can on the one hand guarantee optimal indication of the path to the desired destination, e.g. to the door 20 to the bathroom, and on the other hand ensure that the sleep rhythm is not or only slightly affected. In this context, the incorporation of a brightness sensor 4 in the lighting module 100 can be particularly advantageous, since the control unit 2 can then set the brightness of the light spots 50a, . . . , 50d; 60a, . . . , 60d in a defined manner as a function of the ambient brightness or as a function of the brightness measured value provided by the brightness sensor 4.

In the third exemplary embodiment, the lighting module 100 comprises a respective adjustment device downstream of the control unit 2 for adjusting the rotational position and/or inclination for each of the individual lighting elements 1a, . . . , 1d as previously described. Furthermore, the lighting module 100 in the third exemplary embodiment has a brightness sensor 4 and additionally a real-time clock, both of which are in data connection with the control unit 2. Thus, depending on the time of day and the brightness in the room, for example, the control unit 2 can use the lighting elements 1a, . . . , 1d to generate different light spots 50a, . . . , 50d; 60a, . . . , 60d, which indicate different paths, as this is indicated schematically in FIG. 6.

In the third exemplary embodiment, at night, for example in a period of time between 9:00 p.m. and 6:00 a.m. and/or when the brightness measured value provided by the brightness sensor 4 falls below a predetermined threshold value, the path from the care bed 30 to the door 20 to the bathroom is indicated when the motion sensor 3a and the vibration sensor 3b detect that the person is leaving the care bed 30. For this purpose, the rotational and pivoting positions or inclinations of the individual lighting elements 1a, . . . , 1d are set by the control unit 2 and the individual lighting elements 1a, . . . , 1d are activated or switched on one after the other in such a way that the light spots 50a, . . . , 50d indicate the path to the door 20 into the bathroom. In addition, the brightness of the individual lighting elements 1a, . . . , 1d is adjusted by the control unit 2 in accordance with the brightness measured value provided by the brightness sensor 4, e.g. to avoid an excessively glaring illumination.

During the day, for example in a period of time between 6:00 a.m. and 9:00 p.m. and/or when the brightness measured value provided by the brightness sensor 4 exceeds a predetermined threshold value, the rotational and pivoting positions or inclinations of the individual lighting elements 1a, . . . , 1d are set by the control unit 2 and the individual lighting elements 1a, . . . 1d are activated or switched on one after the other in such a way that the path from the care bed 30 to the door 40 into the kitchen is indicated when the motion sensor 3a and the vibration sensor 3b detect that the person is leaving the care bed 30.

Optionally, as in the third exemplary embodiment, selected or all lighting elements 1a, . . . , 1d in all conceivable exemplary embodiments of a lighting module 100 according to the invention can also comprise multi-color light sources 5a, . . . , 5d, for example multi-color light-emitting diodes or multiple light-emitting diodes emitting light of different wavelengths. In this case, the control unit 2 can determine the time of day, e.g. by means of an integrated real-time clock, for the specification of the light color emitted by the light sources 5a, . . . , 5d and select the light color emitted by the light sources 5a, . . . , 5d as a function of the time of day and/or select it as a function, e.g., of a brightness measured value determined by a brightness sensor 4.

In the third exemplary embodiment, for example, blue and green light-emitting diodes are provided as light sources 5a, . . . , 5d, which, controlled by the control unit 2, generate blue light spots 50a, . . . , 50d that indicate the path to the door 20 into the bathroom, and green light spots 60a, . . . , 60d that indicate the path to the door 40 into the kitchen.

Optionally, in all conceivable exemplary embodiments of a lighting module 100 according to the invention, the lighting module 100 can also comprise a voice control system that allows a patient to select via voice control which light spots 50a, . . . , 50d; 60a, . . . , 60d are to become active.

Generally, in all conceivable exemplary embodiments of a lighting module 100 according to the invention, a battery 12 can be provided, as schematically shown in FIG. 7. If a lighting module 100 according to the invention has a battery 12, as in the third exemplary embodiment, this can be accommodated in its own segment 8 or in a common segment 8 with the control unit 2, and can be charged via a plug, e.g. a USB plug. Such a segment with a battery 12 can be arranged rigidly, i.e. without the possibility of rotation, on the lighting module 100. Such a segment 8 can also optionally include a battery management system.

Optionally, in all conceivable exemplary embodiments of a lighting module 100 according to the invention, it can also be provided that the control/sensor segment 8a comprises such a battery 12. Optionally, the control unit 2 can read data, such as the charge level, from the battery 12 via a bus system. The control unit 2 can then, for example, switch on a light source 5, for example the stationary light source 5e, in order to emit a warning message indicating that the battery charge level is low. Optionally, the control unit 2 can also communicate via a wireless communication connection, for example, to a caregiver that the battery level is low and recharging is required.

A segment 8 with a battery 12 can also be designed in such a way that its outer wall is translucent. Behind this outer wall around the battery 12, light sources 5 can be mounted, wherein, for example, light sources 5 with two different light colors such as warm white and cool white light-emitting diodes can be used.

Such light sources 5 can be connected downstream of the control unit 2, and depending on the time of day or brightness measured value, the control unit 2 can activate the light sources 5 with a specific light color, e.g. cold white when waking up and during the day, and warm white in the morning, evening, and when going to sleep. The control unit 2 can also be designed to activate such light sources 5 with a certain brightness and/or light color in such a battery segment only when falling asleep and when waking up for energy saving reasons, in order to facilitate falling asleep for persons who are afraid of the dark.

All conceivable exemplary embodiments of a lighting module 100 according to the invention can also be designed independently of an external power source. In this case, the lighting module 100 can include a solar or photovoltaic segment, wherein said solar or photovoltaic segment includes a solar or photovoltaic cell connected to and charging a battery 12 of the lighting module 100.

Optionally, a lighting module 100 having such a solar or photovoltaic segment and a battery 12 can also include a brightness sensor 4 as previously described. For example, during the daytime, when the brightness measured value of the lighting module 100 determined by the brightness sensor 4 in the environment of the lighting module 100 exceeds a predetermined brightness threshold, parts of the lighting module 100 or the entire lighting module 100 can be deactivated and the battery 12 can be charged by the solar or photovoltaic cell.

At night, when the brightness measured value of the lighting module 100 determined by the brightness sensor 4 in the environment of the lighting module 100 is below the predetermined brightness threshold value, the lighting module 100 can be ready for use and the control unit 2 can be ready for activating or deactivating or dimming selected individual lighting elements 1a, . . . , 1d.

Optionally, in addition or as an alternative to a brightness sensor 4, the control unit 2 can comprise or be connected to a real-time clock so that the control unit 2 has the current time and can distinguish between day and night cycles by means of a real-time clock.

Optionally, in all conceivable exemplary embodiments of a lighting module 100 according to the invention, a segment 8 of the lighting module 100 can also have a USB or SD port to which a USB stick or a memory card can be connected, which may contain, for example, familiar music from the patient's childhood, which can then be played, for example, by means of the control unit 2. In this way, familiar memories of their childhood, for example, can be awakened in persons with dementia, which can have a calming effect. In a similar way, familiar smells can also awaken familiar memories of their childhood in persons with dementia.

Therefore, a lighting module 100 according to the invention can optionally also comprise a segment 8 with a device for dispensing room fragrances, which can be dispensed in a controlled manner by the control unit 2.

Optionally, in all conceivable exemplary embodiments of a lighting module 100 according to the invention, the lighting module 100 can also comprise a microphone and/or speaker so that the patient can communicate with the lighting module 100 or with caregivers or others via voice control, if applicable, as well as listen to music or radio via the lighting module 100, if applicable.

Optionally, in all conceivable exemplary embodiments of a lighting module 100 according to the invention, a segment 8 of the lighting module 100 can also comprise a sensor 3 in data communication with the control unit 2 for measuring, for example, the CO₂ content, or also the temperature or air humidity in the environment of the lighting module 100. If the CO₂ measured value determined by the sensor 3 exceeds a predetermined threshold value, the control unit 2 can activate, for example, a predetermined lighting element 1a, . . . , 1d or, for example, a stationary light source 5e, as present in the third exemplary embodiment in FIG. 7, to emit an alarm signal.

Optionally, in all conceivable exemplary embodiments of a lighting module 100 according to the invention, the lighting module 100 can also comprise a communication unit 10, for example with WLAN or Bluetooth capability, as schematically shown in FIG. 1. Such a communication unit 10 is connected downstream of the control unit 2 and can establish a communication connection with, for example, at least one vital parameter sensor, in particular with WLAN or Bluetooth capability, for monitoring a vital parameter such as pulse, blood pressure, respiratory rate, blood sugar or body temperature, of a person, which can be arranged on the person or patient, for example. In this case, the control unit 2 is designed to activate selected lighting elements 1a, . . . , 1d and/or a stationary light source 5e, as present in the third exemplary embodiment in FIG. 7, when the measured vital parameter exceeds or falls below a predetermined threshold value.

In this way, it is possible to communicate effectively with caregivers when a person needs help, or even, as described previously, when, for example, the air quality in the room is poor and a caregiver should open the window to improve the air quality. This communication between the lighting module 100 and caregivers allows for reduced patrols, more restful sleep, and more time for interpersonal interaction.

Optionally, a recording of the sleep rhythm can also be made by means of a lighting module 100 according to the invention, for example by using a vibration sensor 3b of the lighting module 100 to register and measure the movements of the patient and thus record the depth of sleep and further information about the patient's sleep from the control unit 2. Such information can also be communicated by means of the communication unit 10 to the caregivers or to a data recording unit, so that the caregivers can monitor the sleep rhythm, or retrieve it directly from the lighting module 100 in the morning, e.g. via a display, or USB connection.

Optionally, communication with external software can also take place by means of the communication unit 10, so that the caregivers are informed when the person leaves the care bed 30, or about the duration of this leaving of the bed, as well as by the vibration sensor 3b about the sleep rhythm or the sleep state, as well as possibly about other measurement data that the lighting module 100 measures or records, e.g. also CO₂ content in the air etc.

In all conceivable exemplary embodiments of a lighting module 100 according to the invention, it can be provided that the control unit 2 records all measurement results and anonymizes this data, wherein this data can be forwarded to a central further processing unit, which receives anonymized data from a very large number of lighting modules 100, evaluates them and can thus obtain extended knowledge through the amount of different, possibly anonymized data. For example, the vibration sensors 3b in the lighting modules 100 can be used to record the sleep rhythm of a large number of people and evaluate it in the anonymized evaluation in the central further processing unit, and new knowledge can thus be obtained, for example, about the sleep rhythm of people with a particular clinical picture. In doing so, an input device, either directly on the lighting module 100 or through a wireless communication connection, can optionally be used to enter the patient's clinical picture so that the data, which is later anonymized, can be better categorized and more meaningful insights can be gained.

In particular, for example, the following patient-related values can be determined and, if necessary, forwarded to the caregivers and, if applicable, to a central data evaluation center for anonymized data evaluation:
Registration of bed exit, i.e. when the person leaves the care bed 30,
Detection of bed entry, i.e. when the person returns to the care bed 30,
Movements in the care bed 30
Sleep rhythm
Breathing rate, pulse, sounds, . . .
Moisture level
(Sleeping) position in bed

Furthermore, in all conceivable exemplary embodiments of a lighting module 100 according to the invention, it can optionally also be provided that the lighting module 100 comprises a segment 8 with an integrated thermal imaging camera by means of which the body temperature of the patient can be measured, or monitored and observed. This can be particularly helpful for caregivers when the patient is ill, e.g. has a fever, wherein this makes it easier to check the patient's health status.

Optionally, the control unit 2 can also derive, e.g. by means of artificial intelligence, the resulting optimal environmental conditions with regard to brightness, air quality, bed inclination, humidity, etc., based on the currently recorded data, thus providing further support for the caregivers and for the persons to be cared for themselves.

These recommended settings as well as critical threshold overshoots or undershoots of measured vital parameters or other recorded measured values can, if necessary, be transmitted, e.g. via a WLAN or Bluetooth communication connection, by means of the communication unit 10 to e.g. a display module, such as a smartphone, and thus be displayed to the caregivers.

It is true that two exemplary embodiments of a lighting module 100 according to the invention have been described previously, which can be used particularly advantageously in care facilities and in the support or care of persons in need of care. However, a lighting module 100 according to the invention can be used in a wide variety of areas.

For example, a lighting module 100 according to the invention, as previously described, can provide emergency lighting to indicate to persons in a building the escape route to an emergency exit. For this purpose, for example, a single lighting module 100 can be arranged, for example, on the ceiling, on the floor or on a wall of a room in order to indicate to persons, in an emergency, the escape route out of the room by means of light spots 50.

In this case, the control unit 2 switches on the individual lighting elements 1a, . . . , 1d when the CO₂ measured value in the environment of the lighting module 100, determined for example by a chemical sensor 3 designed as a CO₂ detector, exceeds a predetermined threshold value or the change over time of the measured value determined by the sensor exceeds a predetermined threshold value, thus indicating the path to the escape route. For this purpose, the rotational and/or pivoting positions can already be set manually or automatically in advance by the control unit 2 in order to achieve rapid illumination of the escape route.

Optionally, a whole series of lighting modules 100 according to the invention can also be arranged throughout the building, each comprising a communication unit 10, in particular with WLAN or Bluetooth capability, wherein the communication unit 10 is connected downstream of the control unit 2 of the respective lighting module 100. The communication units 10 are designed to establish a communication connection with further, in particular similarly constructed, lighting modules 100′ and/or, for example, lighting units with WLAN or Bluetooth capability.

If a measured value is determined by at least one sensor 3, e.g. a CO₂ sensor of a lighting module 100, in a room, which exceeds, for example, a predetermined threshold value, the control unit 2 can activate and/or deactivate selected lighting units and/or dim their brightness and/or control the control unit of selected further lighting modules to activate and/or deactivate and/or dim the brightness of selected lighting elements of the further lighting modules, so that persons can quickly escape from the building by being guided from one lighting module 100 to the next.

1-19. (canceled)

20. A lighting module for a controlled emission of light, the lighting module comprising:
at least two lighting elements, wherein individual ones of said lighting elements being disposed rotatably and are each disposed pivotably;
a controller in communication connection with individual ones of said lighting elements;
at least one sensor for measuring at least one parameter in an environment of the lighting module, wherein said at least one sensor is in communication connection with said controller, wherein said at least one sensor is configured to determine measured values of the at least one parameter; and
said controller is configured to activate selected ones of said lighting elements individually.

21. The lighting module according to claim 20, wherein said controller is configured to deactivate selected ones of said lighting elements individually when a measured value corresponding to at least one predetermined criterion is determined by said at least one sensor.

22. The lighting module according to claim 20, wherein said controller is configured to individually activate and/or deactivate selected said lighting elements and/or to adjust their brightness in a predetermined sequence.

23. The lighting module according to claim 20, wherein said at least one sensor is:
a motion sensor; or
a vibration sensor; or
a photoelectric sensor; or
a sensor that is sensitive to at least one chemical substance.

24. The lighting module according to claim 20, wherein said controller is configured to use at least one of a following criteria for activating and/or deactivating and/or adjusting a brightness of said lighting elements:
a measured value of the at least one parameter determined by said at least one sensor which indicates a movement of a person in the environment of the lighting module;
the measured value of the at least one parameter determined by said at least one sensor indicates that no said person is moving in the environment of the lighting module;
a change over time of the measured value of the at least one parameter determined by said at least one sensor exceeds a predetermined threshold value; and
the measured value of the at least one parameter determined by the at least one sensor exceeds the predetermined threshold value.

25. The lighting module according to claim 24, wherein:
said at least one sensor includes a motion sensor and a vibration sensor; and
said controller is configured to:
upon simultaneous detection of a movement of the person in the environment of the lighting module by said motion sensor and said vibration sensor, activate said lighting elements individually in a predetermined sequence;
deactivate said lighting elements if no movement of the person in the environment of the lighting module is detected by said motion sensor and said vibration sensor; and
upon detection of the movement of the person in the environment of the lighting module only by said motion sensor, activates said lighting elements individually in reverse order.

26. The lighting module according to claim 20, wherein:
said at least one sensor is one of a plurality of sensors of a same type and are disposed on the lighting module in such a manner that each of said sensors measures at least one physical and/or chemical parameter in a predetermined subregion of the environment of the lighting module;
a lighting element of said lighting elements is assigned to each of said sensors; and
said controller is configured to activate and/or deactivate said lighting element assigned to a respective sensor of said sensors and/or to adjust its brightness, when a measured value corresponding to at least one predefined criterion is determined by said respective sensor.

27. The lighting module according to claim 20,
further comprising a brightness sensor for determining a brightness measured value of a brightness in the environment of the lighting module, wherein said brightness sensor is in data communication with said controller; and
wherein said controller is configured to adjust the brightness of said lighting elements in dependence on the brightness measured value determined by said brightness sensor.

28. The lighting module according to claim 20, wherein each of said lighting elements contains the following components:
a light source; and
a lens and/or a focusing element for adjusting an environmental area illuminated by said light source.

29. The lighting module according to claim 27, wherein:
each of said lighting elements contains multi-color light sources;
said controller is configured to:
select a light color emitted by said multi-color light sources in dependence on the brightness measured value determined by said brightness sensor; and/or
determine a time of day and select the light color emitted by said multi-color light sources depending on the time of day.

30. The lighting module according to claim 27, wherein:
each of said lighting elements has an adjustment device for adjusting a rotational position and/or an inclination of a respective lighting element, wherein said adjustment device is connected downstream of said controller;
said controller is configured to:
adjust the rotational position and/or the inclination of said respective lighting element in dependence on the brightness measured value determined by said brightness sensor by means of said adjustment device; and/or
determine a time of day and adjust the rotational position and/or the inclination of said respective lighting element in dependence on the time of day by means of said adjustment device.

31. The lighting module according to claim 20, wherein the lighting module is modularly constructed from a plurality of individual segments, wherein each of said lighting elements is accommodated in each case in a separate one of said segments, and wherein the lighting module is expandable by further segments.

32. The lighting module according to claim 31, wherein the lighting module has a substantially cylindrical shape.

33. The lighting module according to claim 31, wherein selected ones of said segments of the lighting module are rotatable about a longitudinal axis of the lighting module.

34. The lighting module according to claim 31, wherein one of said segments is a common control/sensor segment accommodating said controller and said at least one sensor, said common control/sensor segment forms one end of the lighting module and/or said common control/sensor segment has a stationary light source connected downstream of said controller.

35. The lighting module according to claim 20, further comprising a holding device configured for fastening the lighting module on a piece of furniture.

36. The lighting module according to claim 20, further comprising a communication unit connected downstream of said controller, wherein:
said communication unit is configured to establish a communication connection with further lighting modules and/or lighting units with wireless local-area network or Bluetooth capability; and
said controller is configured, when a measured value corresponding to at least one predetermined criterion is determined by said at least one sensor, to activate and/or deactivate selected said lighting units and/or dim their brightness and/or to control a control unit of selected further lighting modules to activate and/or deactivate and/or dim a brightness of selected said lighting elements of the selected further lighting modules.

37. The lighting module according to claim 28,
further comprising a communication unit connected downstream of said controller, said communication unit being configured to establish a communication connection with at least one vital parameter sensor for monitoring a vital parameter; and
wherein said controller is configured to activate selected said lighting elements and/or said light source being a stationary light source if the vital parameter measured exceeds or falls below a predetermined threshold value.

38. The lighting module according to claim 20,
further comprising a communication unit connected downstream of said controller, said communication unit being configured to establish a communication connection with at least one external sensor for measuring at least one physical and/or chemical parameter; and
wherein said controller is configured to keep selected said lighting elements in a deactivated state if the physical and/or chemical parameter measured by the at least one external sensor indicates a movement of a person in the environment of the external sensor.

39. The lighting module according to claim 20, wherein:
said individual ones of said lighting elements are disposed rotatably, about a common axis, and are each disposed pivotably, with respect to the common axis;
said at least one sensor measures at least one physical and/or chemical;
said at least one sensor is configured to determine, repeatedly at predetermined times, the measured values of the at least one parameter; and
said controller is configured to activate selected ones of said lighting elements individually to switch them on, and/or to adjust their rotational and/or pivoting position when a measured value corresponding to at least one predetermined criterion is determined by said at least one sensor.
